(19) United States
(12) Patent Application Publication
(10) Pub. No.: US 2013/0132998 A1
(43) Pub. Date: May 23, 2013

(54) SENDING A MESSAGE WITHIN A TELEVISION-CONTENT DELIVER ENVIRONMENT

(71) Applicants: Nitya Narasimhan, Hopewell Junction, NY (US); Aroon V. Tungare, Windfield, IL (US); Venugopal Vasudevan, Palatine, IL (US); Joseph F. Wodka, Hoffman Estates, IL (US)

(72) Inventors: Nitya Narasimhan, Hopewell Junction, NY (US); Aroon V. Tungare, Windfield, IL (US); Venugopal Vasudevan, Palatine, IL (US); Joseph F. Wodka, Hoffman Estates, IL (US)

(73) Assignee: GENERAL INSTRUMENT CORPORATION, Horsham, PA (US)

(21) Appl. No.: 13/300,690

(22) Filed: Nov. 21, 2011

(51) Int. Cl. H04N 21/43

(52) U.S. Cl. 725/34

(57) ABSTRACT

Subscribers to a television-delivery service can send and receive messages within a television-viewing environment. A subscriber can create a message, attach content from the television environment, and send the message to a friend, all without leaving the television environment. A television producer controls its rights to the content by allowing subscribers to select and send some content while preventing other content from being incorporated in a message. Rights can be checked at the sender site, at the recipient site, and in between by a message-transport service. In some situations, the recipient may not have sufficient rights to view the entire message. Specifically, the recipient's subscription level may not allow access to some of the message content that was pulled from the sender's television-delivery service. In this case, the recipient may take corrective action or may view the message with the restricted content replaced with alternative content.

### FIELD OF THE INVENTION

The present invention is related generally to television-content delivery systems and, more particularly, to creating and sending messages using those systems.

### BACKGROUND OF THE INVENTION

People are quickly adopting new communications modes that are enabled by new digital technologies. E-mail, SMS, and “tweeting” are replacing traditional paper cards and letters for personal (and business) communications. Many people are using the new modes to instantly share photographs, video clips, and other media content with their friends.

Much of the media content that users wish to share originates in a television environment. Television, in some ways a long established media technology, is changing to support more interactivity and user choice.

However, some barriers still separate one communication technology from another. For example, a user may watch a television show, become enamored of a particular scene, and wish to share that scene with his friends. To do so, he may have to leave the television-viewing environment and search online to see if anyone has posted a copy of that scene on a web site. If he finds such a posting, he can then send an e-mail with a link to the post. It is clumsy and inconvenient for the user to move from one communications environment (television) to another (web and e-mail) to share the scene.

This crossing of communications barriers to share a television scene with friends can also be of dubious legality. If, for example, the producer of the television content did not surrender rights to have that content posted on the web, then the posting person as well as anyone who copies or views the posting may be violating the producer's copyright.

The business of media production is based strongly on user-subscription fees (and advertising), and media producers are very interested in new technologies that protect their revenue streams by limiting unauthorized distribution of their content. While the producers' concerns are legitimate and perfectly understandable, they create conflicts with their subscribers who have become used to freely sharing media content with one another.

### BRIEF SUMMARY

The above considerations, and others, are addressed by the present invention, which can be understood by referring to the specification, drawings, and claims. The present invention allows subscribers to a television-delivery service to send and receive messages within a television-viewing environment. A subscriber can create a message, attach content from the television environment (e.g., a still or a clip from a current television show), and send the message to a friend, all without leaving the television environment.

When the message sender and the intended recipient of the message both have subscriptions to television-content delivery services, the subscription providers can control the content allowed to be sent in the message. A television producer controls its rights to the content by allowing subscribers to select and send some content while preventing other content from being incorporated in a message. Rights can be checked at the sender site, at the recipient site, and in between by a message-transport service.

In some embodiments, the addresses of the sender and recipient are defined only within the television-delivery environment, thus preventing content from “leaking” out of this environment to possibly unauthorized viewers. In other embodiments, the television producer may allow at least some content to be sent to addresses outside of the television subscription world (e.g., to a standard e-mail address).

The sender can include other content in the message and can attach delivery criteria to the message. Generally, all of the content in the message is delivered to the recipient once the delivery criteria are satisfied. In some situations, however, the recipient may not have sufficient rights to view the entire message. Specifically, the recipient's subscription level may not allow access to some of the message content that was pulled from the sender's television-delivery service. In this case, some embodiments allow the recipient to take corrective action, such as subscribing to a more inclusive television-delivery package that would permit the recipient to view the restricted content. The recipient may also be given the option of viewing the message with the restricted content replaced with alternative content (e.g., a lower-resolution version of a selected scene or a still instead of a video clip).

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIG. 3 is a flowchart of a representative method for sending a message in the environment of FIG. 1;

FIG. 4 is a flowchart of a representative method for receiving a message in the environment of FIG. 1; and

FIG. 5 is a flowchart of a representative method for transporting a message in the environment of FIG. 1.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

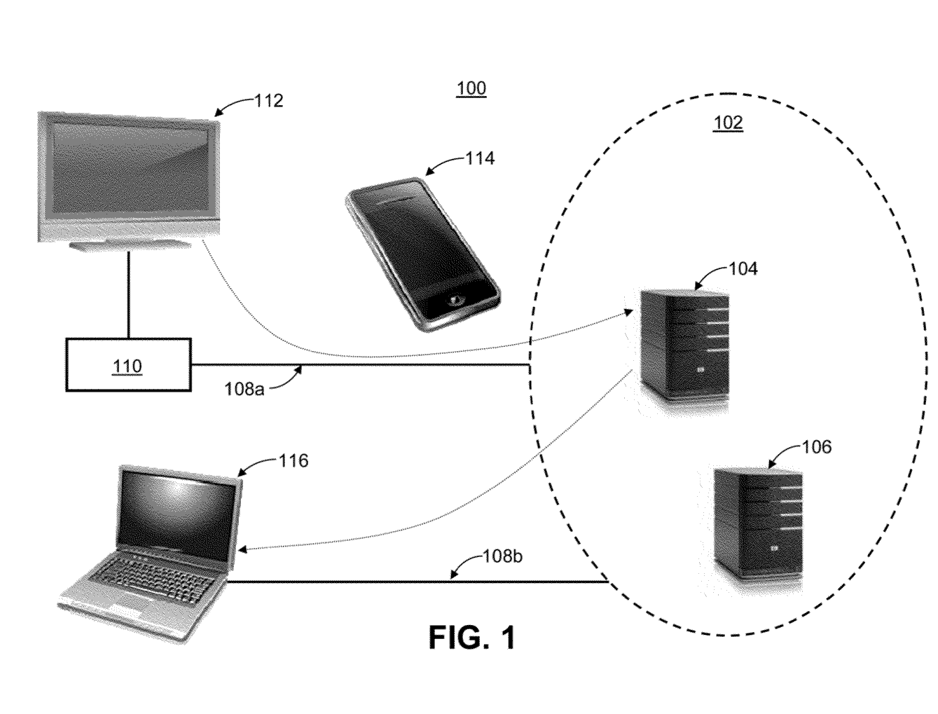

Aspects of the present invention may be practiced in the representative communications environment 100 of FIG. 1. Connected together via any or all of various known networking technologies 102 are servers such as television-channel providers 104 and message-transporter servers 106. For ease of illustration, only one of each type of server 104, 106 is shown, but multiples of each can exist and can work together, as discussed below.

The channel providers 104 provide, via the networking technologies 102, subscription television content-delivery services to end-user devices. Traditional end-user devices are supported by “wireline” network technologies (e.g., fiber, wire, and cable) 108a, 108b. For example, a set-top box 110 generally receives television programming from various channel providers 104 and provides a user interface (e.g., an interactive program guide) for selecting and viewing content from the cable provider. A digital video recorder (not shown) can store programming for later viewing. Video content may be viewed on a television monitor 112. In some situations, a laptop computer 116 can access both television content and web-based services either wirelessly or via the wireline network 108b. A home gateway, kiosk, digital sign, or media-restreaming device (not shown) are other possible end-user devices.

(A media-restreaming device transfers content between disparate types of networks. For example, it receives content from a cable system 108a and then transmits that content over a local radio link such as WiFi to the cellular telephone 114. The media-restreaming device usually operates in both directions to carry messages between the networks. In some embodiments, aspects of the present invention are practiced by a media-restreaming device.)

As indicated above, television programming can also be delivered to non-traditional subscriber devices such as the cellular telephone 114. This telephone 114 communicates wirelessly to a wireless base station (not shown but known in the art) to access the public switched telephone network, the Internet, or other networks to access web-based services as well as the television-delivery services provided by the channel servers 104.

To illustrate aspects of the present invention, consider a user watching a television program on the television monitor 112. The programming is delivered to the set-top box 110 by the cable system 108a from one or more channel providers 104. The user sees a scene on the program that he would like to share with a friend. An application running on the set-top box 110 embodying aspects of the present invention allows him to create a message addressed to his friend and to include in the message the scene (or a pointer to that scene). (For the sake of simplicity, the present discussion assumes that the message-creation application is fully embodied on the set-top box 110, but in other embodiments this application can reside at least partially within the head-end of a cable provider, on web servers, on an end-user device such as the cellular telephone 114, or on some combination of these.)

The message is carried, possibly through the message transporter 106, to the delivery address of the friend. In this case, the message is delivered to the friend's laptop 116 which he uses to access a subscription television service delivered via the cable 108b from one or more channel providers 104. The friend is alerted to the presence of the message. When he opens the message, he can view the content shared by the sender.

In this example, the sender and receiver could be served by different television-subscription services. Even so, the producer's rights to the content are protected. In some embodiments, these rights are protected by restricting the pool of potential recipients, that is, of delivery addresses, so that protected content does not “leak out” of the television-subscription environment which is fenced in and strongly protected by the content providers. Other embodiments employ sophisticated security measures to allow the content be safely sent to devices beyond the direct control of the content providers.

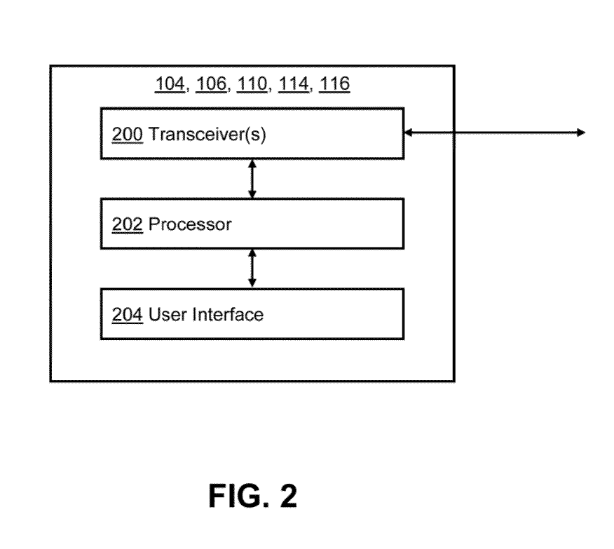

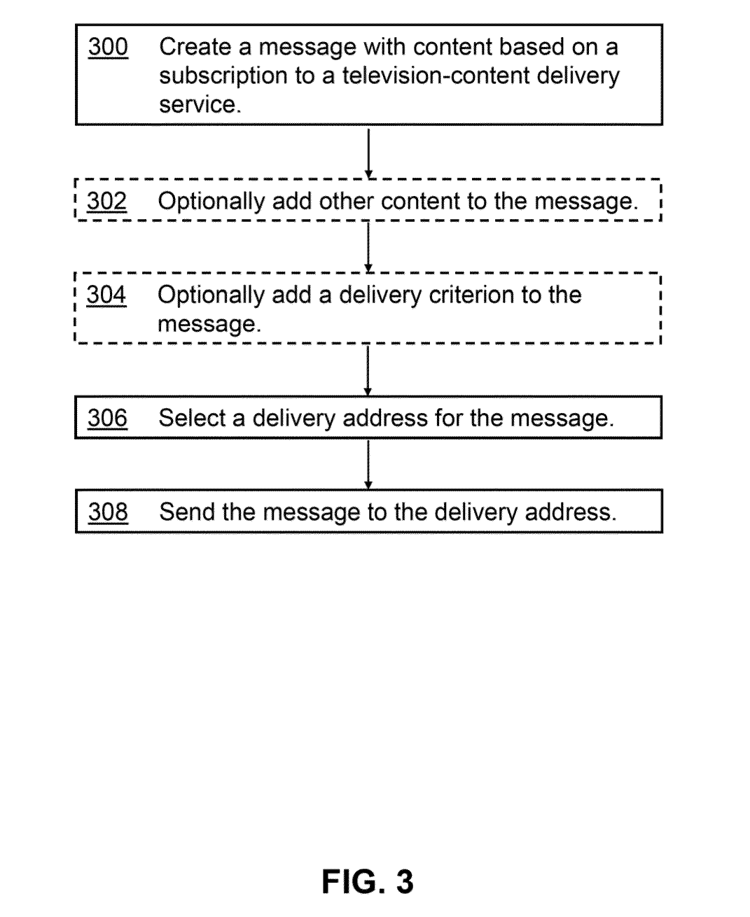

FIG. 2 shows the major components of a representative channel provider 104, message transporter 106, or end-user device 110, 114, 116. Network interfaces (also called transceivers) 200 send and receive media presentations and messages. A processor 202 controls the operations of the device and, in particular, supports aspects of the present invention as illustrated in FIGS. 3 through 5, discussed below. The user interface 204 supports a user's (or administrator's) interactions with the device. Specific uses of these components by specific devices are discussed as appropriate below.

FIG. 3 presents one method for sending a message in the environment of FIG. 1. In step 300, a user interface assists the user in creating a message. The user interface can be presented, for example, by the set-top box 110 on the television monitor 112. (Other devices can use other means for presenting a user interface.) In any case, the interface allow the user to specify the programming content that he wants to include in the message.

In some embodiments, this user interface is tied to an electronic program guide provided as part of the television-content delivery service. This allows the user to browse through content offerings, including, potentially, video-on-demand. Thus, the user is not restricted to only that content that happens to be showing when he chooses to create the message.

However, the provider of the television content may impose restrictions on the content that can be included in the message. For example, the provider may allow only still images or video clips shorter than, say, 15 seconds to be included in the message. Another restriction could prevent premium content from being selected. The reasons for these restrictions is that the content provider makes money by providing content and does not want that content to become too freely available. In some embodiments, the message-creation application can communicate with the television-content provider while the message is being created to ensure that only allowable content is included in the message. In other embodiments, content restrictions are enforced later, when the message is sent or when it is delivered.

Note that the message need not be a greeting from one friend to another. A commercial entity could create and send a message, such as an advertisement. The television provider could itself send a message to its subscribers to, for example, notify them of a new service offering or of billing matters. In some embodiments, a public entity could send a public-service message to everyone currently watching television.

In step 302, the sender can choose to add other content to the message, such as a text message.

The sender may add delivery criteria to the message in step 304. If, for example, the message is a birthday greeting, then the sender can specify that the message not be available to the recipient until the recipient's birthday, even if the message is delivered to the recipient's device before that day. The sender can specify authentication criteria so that only the intended recipient can open the message.

Some delivery criteria are unique to the television-content delivery environment. The sender can state the message only be delivered when the recipient is watching a particular television program or any program on a particular channel. Some delivery criteria may be more suitable to a commercial entity sending an advertisement than to a person sending a personal greeting to a friend.

The sender chooses the recipient for the message in step 306. In some embodiments, the recipient must be a subscriber device (e.g., the laptop 116) associated with the same television-content delivery service to which the message sender is subscribed. That restriction makes it easy for the content producer to protect his rights to limit the distribution of content. If the recipient device 116 is not associated with the sender's subscription provider, then the content allowed in the message may be restricted in some fashion.

Other embodiments allow the recipient to be associated with a different subscription provider than that of the sender. Business arrangements can be made between the subscription providers to allow for some cross-subscription transmission of content.

In the most open embodiments, the recipient address need not be within the television-delivery environment at all. The address could be, for example, a standard e-mail address. The content provider may allow only old content to be sent to such an address.

The recipient address may even specify a person or a group of persons instead of a physical device 116. In that case, the delivery of the message is more complicated but more flexible.

The message, containing either the selected content itself or metadata referring to the content, is sent to the recipient address in step 308.

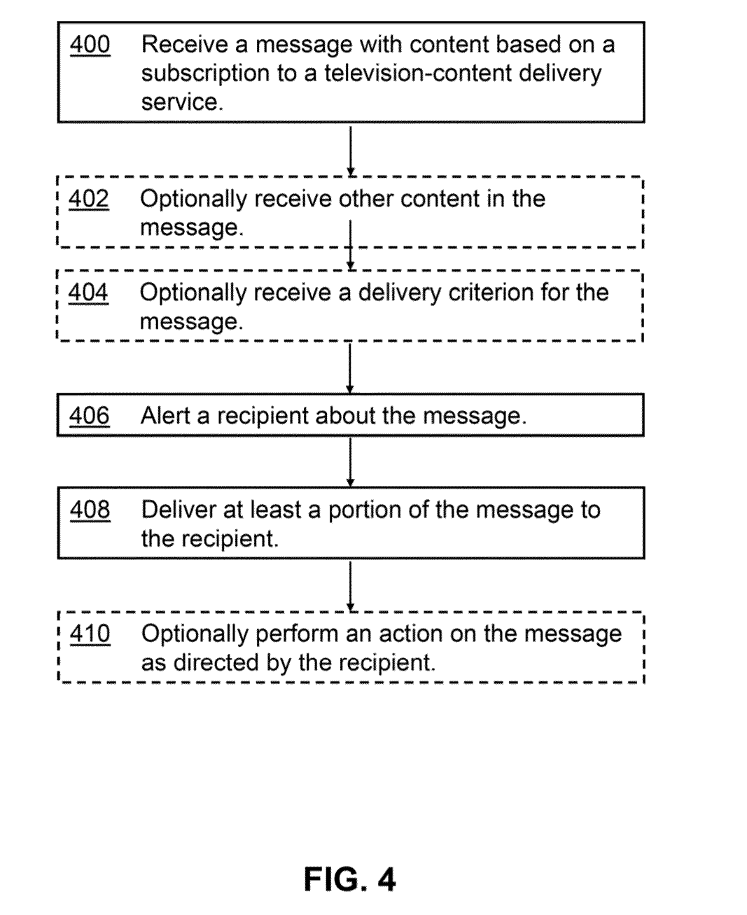

FIG. 4 presents a method for a recipient end-user device 116 to follow. In step 400, the recipient 116 receives the message with the media content. The message may also contain other content (step 402). If the message includes only metadata describing the media content rather than the content itself, then the recipient end-user device 116 requests that its channel provider 104 download the actual content to it. This would be a convenient time for the channel provider 104 to check if the message complies with the digital-rights policies of the content provider. If the message violates those rights, then the recipient device 116 may alert a local user to the existence of the message (step 406) without delivering the media content in the message.

If the message is associated with delivery criteria, such as “do not deliver before,” then the recipient device 116 waits until those criteria are satisfied (step 404) before proceeding to the next step.

In step 406, a local user is alerted about the existence of the message, and the message is delivered in step 408. In some embodiments, these steps are implemented via a user interface to a messaging application that presents a pop-up alert on the screen that the local user is currently watching.

The local user receiving the message can perform actions on the message in step 410. The user may, for example, delete the message, acknowledge it, or forward it to yet another recipient. In the last case, the rights of the content providers are again checked and safeguarded.

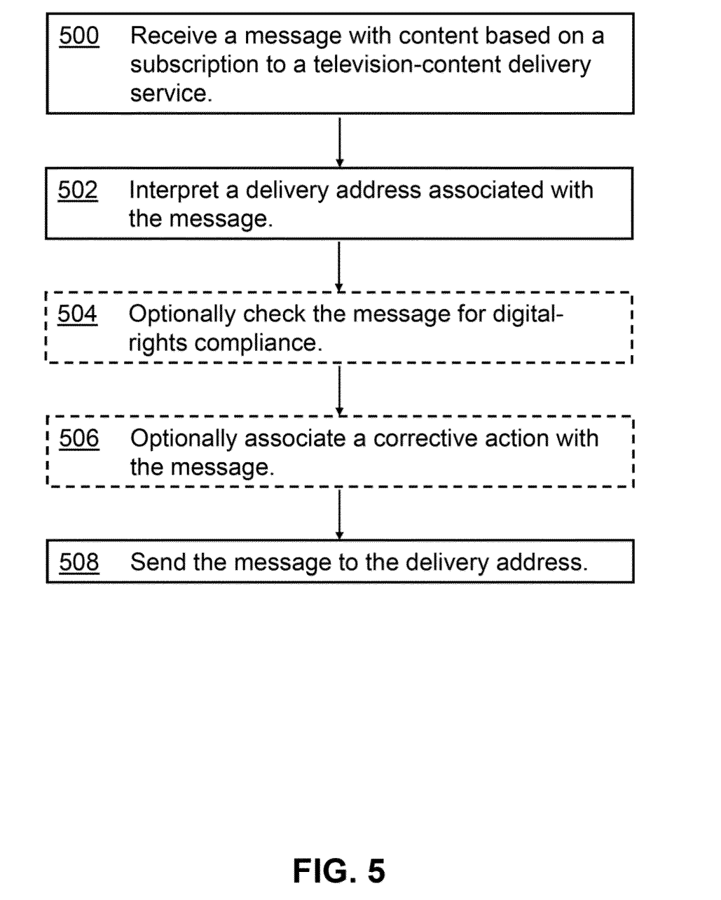

FIG. 5 presents a method for a message-transporter server 106. Steps 500, 502, and 508 are very straightforward: The message server 106 receives a message, interprets the delivery address, and forwards the message on.

Before sending on the message in step 508, the message server 106 can, in step 504, check the message contents for digital-rights compliance. Because the message server 106 can have access to the content providers of both the sender and receiver, it is in a good position to review any rights policies and to enforce any rights. It is therefore expected that the message server 106 will be a more secure rights enforcer than the end-user devices 110, 116.

If the message server 106 discovers a digital-rights problem, then it can take corrective action in step 506. If there is insufficient authorization to transfer the media content contained in the message from the sender to the recipient, then the message server 106 can alter the message by removing the message content and including a proposal to the recipient to upgrade his service so that he can view such transferred content. In some situations, the message server 106 can replace problematic content with allowable content. If, for example, the transfer of premium content is not allowed, then the message server 106 may be able to find suitable non-premium content as a substitute. Or the message server 106 can replace a video clip with a still from the clip.

In view of the many possible embodiments to which the principles of the present invention may be applied, it should be recognized that the embodiments described herein with respect to the drawing figures are meant to be illustrative only and should not be taken as limiting the scope of the invention. For example, aspects of the present invention can be used with any type of television-content delivery system (e.g., broadcast television, cable television, broadcast radio, private radio, a satellite-provided channel, an Internet-provided channel, a local programming-storage device). Therefore, the invention as described herein contemplates all such embodiments as may come within the scope of the following claims and equivalents thereof.

We claim:

1. A method for a subscriber device to send a message, the subscriber device associated with a subscription to a television-content delivery service, the method comprising:
creating, on the subscriber device, the message, the message comprising an element selected from the group consisting of: selected television content from the television-content delivery service and an identifier of selected television content from the television-content delivery service, wherein the creating is based, at least in part, on the associated subscription;
selecting, on the subscriber device, a delivery address; and
sending, by the subscriber device, the message to the selected delivery address.

2. The method of claim 1 wherein the subscriber device is selected from the group consisting of: a server, a set-top box, a television, a personal computer, a mobile telephone, a companion device, and a gaming console.

3. The method of claim 1 wherein message is selected from the group consisting of: an advertisement, a reminder, a personal message, a public-service message, a social-networking update, and a service alert.

4. The method of claim 1 wherein the television content is selected from the group consisting of: a still picture, a segment of video, a segment of audio, and text.

5. The method of claim 1 wherein the television-content delivery service comprises an element selected from the group consisting of: a broadcast television channel, a cable television channel, a broadcast radio channel, a private radio channel, a satellite-provided channel, an Internet-provided channel, and a local programming-storage device.

6. The method of claim 1 wherein the delivery address is associated with an element selected from the group consisting of: a subscriber to the television-content delivery service, a set-top box, a television, a mobile telephone, a personal digital assistant, a personal computer, an electronic picture frame, a tablet computer, a gaming console, a person, and a group of persons.

7. The method of claim 1:
wherein the message further comprises an element selected from the group consisting of: additional content and an identifier of additional content; and
wherein the additional content is provided by an element selected from the group consisting of: a television provider, a person creating the message, and a third-party provider.

8. The method of claim 1 wherein the message further comprises a delivery criterion selected from the group consisting of: deliver the message during a specific time interval, deliver the message during a specific television program, deliver the message on a specific television channel, deliver the message only upon receiving an appropriate authentication, deliver the message to a specific device or to a specific set of devices, deliver the message within a specific context of a recipient of the message, and deliver the message following a specific action taken by a recipient of the message.

9. A subscriber device associated with a subscription to a television-content delivery service, the subscriber device comprising:
a transceiver configured for receiving television content from the television-content delivery service; and
a processor operatively connected to the transceiver and configured for:
creating a message, the message comprising an element selected from the group consisting of: selected television content from the television-content delivery service and an identifier of selected television content from the television-content delivery service, wherein the creating is based, at least in part, on the associated subscription;
selecting a delivery address; and
sending, via the transceiver, the message to the selected delivery address.

10. The subscriber device of claim 9 wherein the subscriber device is selected from the group consisting of: a server, a set-top box, a television, a personal computer, a mobile telephone, a companion device, and a gaming console.

11. A method for a subscriber device to deliver a message, the subscriber device associated with a subscription to a television-content delivery service, the method comprising:
receiving, on the subscriber device, the message, the message comprising an element selected from the group consisting of: selected television content from the television-content delivery service and an identifier of selected television content from the television-content delivery service;
alerting a recipient associated with a delivery address associated with the message; and
delivering at least a portion of the message.

12. The method of claim 11 wherein the subscriber device is selected from the group consisting of: a server, a set-top box, a television, a personal computer, a mobile telephone, a companion device, and a gaming console.

13. The method of claim 11 wherein message is selected from the group consisting of: an advertisement, a reminder, a personal message, a public-service message, a social-networking update, and a service alert.

14. The method of claim 11 wherein the television content is selected from the group consisting of: a still picture, a segment of video, a segment of audio, and text.

15. The method of claim 11 wherein the television-content delivery service comprises an element selected from the group consisting of: a broadcast television channel, a cable television channel, a broadcast radio channel, a private radio channel, a satellite-provided channel, an Internet-provided channel, and a local programming-storage device.

16. The method of claim 11 wherein the recipient associated with the delivery address is selected from the group consisting of: a subscriber to the television-content delivery service, a set-top box, a television, a mobile telephone, a personal digital assistant, a personal computer, an electronic picture frame, a tablet computer, a gaming console, a person, and a group of persons.

17. The method of claim 11:
wherein the message further comprises a delivery criterion selected from the group consisting of: deliver the message during a specific time interval, deliver the message during a specific television program, deliver the message on a specific television channel, deliver the message only upon receiving an appropriate authentication, deliver the message to a specific device or to a specific set of devices, deliver the message within a specific context of a recipient of the message, and deliver the message following a specific action taken by a recipient of the message; and
wherein delivering at least a portion of the message comprises delivering in accordance with the delivery criterion.

18. The method of claim 11 further comprising:
receiving, from a user of the subscriber device, an action associated with the message, wherein the action is selected from the group consisting of: acknowledge the message, save the message, defer the message, delete the message, and forward the message.

19. A subscriber device associated with a subscription to a television-content delivery service, the subscriber device comprising:
a transceiver configured for receiving television content from the television-content delivery service; and
a processor operatively connected to the transceiver and configured for:
receiving the message, the message comprising an element selected from the group consisting of: selected television content from the television-content delivery service and an identifier of selected television content from the television-content delivery service;
alerting a recipient associated with a delivery address associated with the message; and
delivering at least a portion of the message.

20. The subscriber device of claim 19 wherein the subscriber device is selected from the group consisting of: a server, a set-top box, a television, a personal computer, a mobile telephone, a companion device, and a gaming console.

21. A method for transporting a message within a television-content delivery environment, the method comprising:
receiving, on a message transporter, the message, the message comprising an element selected from the group consisting of: selected television content from the television-content delivery environment and an identifier of selected television content from the television-content delivery environment;
interpreting a delivery address associated with the message, the delivery address defined within the television-content delivery environment; and
sending the message to the delivery address.

22. The method of claim 21 further comprising:
checking the message for digital-rights compliance.

23. The method of claim 22 further comprising:
based, at least in part, on the checking for digital-rights compliance, associating a corrective action with the message, wherein the corrective action is selected from the group consisting of: propose that a recipient of the message subscribe to a television-content delivery service in order to view the message and replace at least some content in the message with alternative content.

24. A message transporter for use within a television-content delivery environment, the message transporter comprising:
a transceiver configured for receiving a message, the message comprising an element selected from the group consisting of: selected television content from the television-content delivery environment and an identifier of selected television content from the television-content delivery environment; and
a processor operatively connected to the transceiver and configured for:
interpreting a delivery address associated with the message, the delivery address defined within the television-content delivery environment; and
sending the message to the delivery address.
